(19) United States
(12) Patent Application Publication
(10) Pub. No.: US 2025/0191511 A1
(43) Pub. Date: Jun. 12, 2025

(54) DISPLAY DEVICE AND METHOD OF DRIVING THE SAME

(71) Applicant: SAMSUNG DISPLAY CO., LTD., YONGIN-SI (KR)

(72) Inventors: Hyun Sik HWANG, YONGIN-SI (KR); Tae Hyung KIM, YONGIN-SI (KR); Hee Beom YANG, YONGIN-SI (KR); Yong Sik JUNG, YONGIN-SI (KR)

(21) Appl. No.: 18/796,530

(22) Filed: Aug. 7, 2024

(30) Foreign Application Priority Data
Dec. 6, 2023 (KR) 10-2023-0175259

(51) Int. Cl. G09G 3/20; G06N 3/08

(52) U.S. Cl. CPC G09G 3/2074; G06N 3/08; G09G 2310/027; G09G 2320/0626; G09G 2320/0673; G09G 2330/021; G09G 2330/028

(57) ABSTRACT

A display device includes a display panel including a sub-pixel, a data driver configured to generate a data voltage based on a gamma voltage and provide the data voltage to the sub-pixel, and a gamma voltage generator configured to receive a first gamma lookup table and a second gamma lookup table and generate the gamma voltage based on at least one of the first gamma lookup table and the second gamma lookup table, and provide the gamma voltage to the data driver. The display device trains an artificial intelligence model to generate the second gamma lookup table comprising gamma voltages for a target driving frequency using the first gamma lookup table including gamma voltages for a sample display device driven at different respective sample driving frequencies.

### CROSS-REFERENCE TO RELATED APPLICATION

This patent application claims priority under 35 U.S.C. § 119 to Korean Patent Application No. 10-2023-0175259, filed on Dec. 6, 2023, the disclosure of which is incorporated by reference in its entirety herein.

### 1. TECHNICAL FIELD

The disclosure is directed to a display device and a method of driving the same. More specifically, the disclosure is directed to a display device supporting a plurality of driving frequencies.

### 2. DISCUSSION OF RELATED ART

It is useful to reduce power consumption of a display device, especially in a mobile device such as a smart phone or a tablet computer. Low-frequency driving technology for driving or refreshing a display panel of the display device at a low frequency lower than a normal driving frequency has been developed to reduce power consumption.

Multi-frequency driving (MFD) technology for driving partial areas of the display panel at different driving frequencies may reduce power consumption even in a case where a still image is displayed only in a partial area of the display panel.

The image seen on the display panel starts as digital data with specific values for each pixel of the display panel. This data may undergo gamma correction using gamma voltages. A display driver of the display device may adjust the gamma voltages to fine-tune the brightness of each pixel. However, it may be difficult to select the most optimal gamma voltages that represent the intended grayscale levels but also reduce power consumption.

### SUMMARY

An object of the disclosure is to provide a display device that uses a gamma lookup table generated through an artificial intelligence model.

Another object of the disclosure is to provide a method of driving a display device.

According to an embodiment of the disclosure, a display device includes a display panel including a sub-pixel, a data driver, and a gamma voltage generator. The data drive is configured to generate a data voltage based on a gamma voltage and provide the data voltage to the sub-pixel. The gamma voltage generator is configured to receive a first gamma lookup table and a second gamma lookup table, generate the gamma voltage based on at least one of the first gamma lookup table and the second gamma lookup table, and provide the gamma voltage to the data driver. An artificial intelligence model is trained to generate the second gamma lookup table comprising gamma voltages for a target driving frequency using the first gamma lookup table including gamma voltages for a sample display device driven at different respective sample driving frequencies.

In an embodiment, the display device may further include a memory device configured to store the first gamma lookup table and the second gamma lookup table.

In an embodiment, the display device may further include a memory device configured to store the first gamma lookup table and a parameter of the artificial intelligence model.

In an embodiment, the sample driving frequencies differ from the target driving frequency.

In an embodiment, the artificial intelligence model is trained additionally using at least one of a top voltage, a bottom voltage less than the top voltage, a data swing range, and a gamma voltage of a lowest grayscale among grayscales supported by the display panel.

In an embodiment, the gamma voltage may be determined as a voltage between the top voltage and the bottom voltage.

In an embodiment, a difference between the gamma voltage of the lowest grayscale and the gamma voltage of a highest grayscale among the grayscales may increase as the data swing range increases.

In an embodiment, the first gamma lookup table may include the gamma voltages according to the sample driving frequencies and a dimming level, and the second gamma lookup table may include the gamma voltages according to a target driving frequency and the dimming level.

According to an embodiment of the disclosure, a method of driving a display device may include: receiving a first gamma lookup table including gamma voltages for a sample display device driven at different respective sample driving frequencies; training an artificial intelligence model to generate a second gamma lookup table including gamma voltages for a target driving frequency; generating a gamma voltage of the display device based on at least one of the first gamma lookup table and the second gamma lookup table; and providing the gamma voltage to a data driver of the display device.

In an embodiment, the method may further include storing the second gamma lookup table in a memory device of the display device.

In an embodiment, the method may further include storing a parameter of the artificial intelligence model in a memory device of the display device, where the training additionally uses the parameter.

In an embodiment, the training additionally uses at least one of a top voltage, a bottom voltage less than the top voltage, a data swing range, and a gamma voltage of the display device of a lowest grayscale among grayscales supported by the display device.

In an embodiment, the first gamma lookup table may include the gamma voltages according to the sample driving frequencies and a dimming level, and the second gamma lookup table may include the gamma voltages according to the target driving frequency and the dimming level.

In an embodiment, method may further include the data driver generating a data voltage based on the gamma voltage and the data driving providing the data voltage to a sub-pixel of a display panel of the display device.

According to an embodiment of the disclosure, a display device includes a display panel including a sub-pixel, a data driver, and a driving controller. The driving controller is configured to train an artificial intelligence model to generate the gamma voltage for a target driving frequency using training data including first gamma voltages for a first sample driving frequency and a first dimming level and second gamma voltages for a second sample driving frequency different from the first sample driving frequence and a second dimming level.

The first dimming level and the second dimming level may be the same or different from one another. In an embodiment, the driving controller trains the artificial intelligence model additionally using a top voltage and a bottom voltage less than the top voltage, and the gamma voltage is determined as a voltage between the top voltage and the bottom voltage. In an embodiment, the driving controller trains the artificial intelligence model additionally using a data swing range and a gamma voltage of a lowest grayscale among grayscales supported by the display panel. In an embodiment, a difference between the gamma voltage of the lowest grayscale and the gamma voltage of a highest grayscale among the grayscales increases as the data swing range increases.

The display device according to embodiments of the disclosure may reduce a tact time of the display device and increase image quality of the display device by inferring the gamma voltage using the artificial intelligence model.

### BRIEF DESCRIPTION OF THE DRAWINGS

The above and other features of the disclosure will become more apparent by describing in further detail embodiments thereof with reference to the accompanying drawings, in which:

FIG. 1 is a block diagram illustrating a display device according to an embodiment of the disclosure;

FIG. 2 is a diagram illustrating an example of training an artificial intelligence model for generating a second gamma lookup table of the display device of FIG. 1;

FIG. 3 is a diagram illustrating an example of training data of FIG. 2;

FIG. 4 is a table illustrating an example of a portion corresponding to a dimming level of 1000 nit and a driving frequency of 90 Hz of the training data of FIG. 3;

FIG. 5 is a diagram illustrating an example in which the artificial intelligence model of FIG. 2 generates a second gamma lookup table;

FIG. 6 is a diagram illustrating an example of a portion of a gamma lookup table of the display device of FIG. 1 corresponding to a dimming level of 1000 nit and a driving frequency of 90 Hz;

FIG. 7 is a diagram illustrating an example in which an artificial intelligence model of a display device generates a second gamma lookup table according to an embodiment of the disclosure;

FIG. 8 is a diagram illustrating a top voltage and a bottom voltage;

FIG. 9 is a table illustrating a portion of training data of the display device of FIG. 7 corresponding to a dimming level of 1000 nit and a driving frequency of 90 Hz;

FIG. 10 is a block diagram illustrating a display device according to an embodiment of the disclosure; and

FIG. 11 is a flowchart illustrating a method of driving a display device according to an embodiment of the disclosure;

### DETAILED DESCRIPTION

Hereinafter, an embodiment according to the disclosure is described in detail with reference to the accompanying drawings. It should be noted that in the following description, only portions necessary for understanding an operation according to the disclosure are described, and descriptions of other portions are omitted to not obscure the subject matter of the disclosure. In addition, the disclosure may be embodied in other forms without being limited to the embodiment described herein.

Throughout the specification, in a case where a portion is “connected” to another portion, the case includes not only a case where the portion is “directly connected” but also a case where the portion is “indirectly connected” with another element interposed therebetween. “At least any one of X, Y, and Z” and “at least any one selected from a group consisting of X, Y, and Z” may be interpreted as one X, one Y, one Z, or any combination of two or more of X, Y, and Z (for example, XYZ, XYY, YZ, and ZZ). Here, “and/or” includes all combinations of one or more of corresponding configurations.

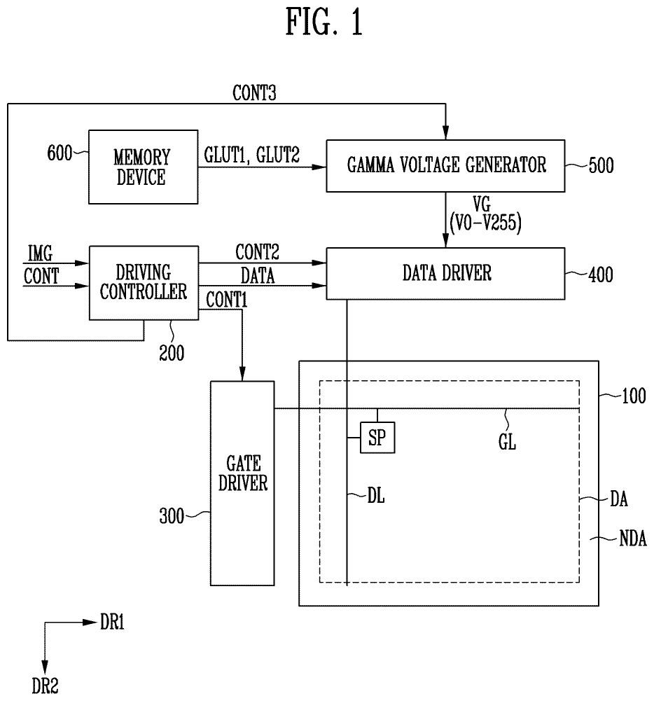

FIG. 1 is a block diagram illustrating a display device according to an embodiment of the disclosure.

Referring to FIG. 1, the display device may include a display panel 100, a driving controller 200 (e.g., a control circuit), a gate driver 300 (e.g., a first driver circuit), a data driver 400 (e.g., a second driver circuit), a gamma voltage generator 500, and a memory device 600. In an embodiment, at least two of the driving controller 200, the data driver 400, the gamma voltage generator 500, and the memory device 600 may be integrated into one chip.

The display panel 100 may include a display area DA that displays an image and a non-display area NDA disposed adjacent to the display area DA. For example, no images may be displayed in the non-display area NDA. In an embodiment, the gate driver 300 may be mounted in the non-display area NDA.

The display panel 100 may include a plurality of gate lines GL, a plurality of data lines DL, and a plurality of sub-pixels SP electrically connected to the gate lines GL and the data lines DL. The gate lines GL may extend in a first direction DR1, and the data lines DL may extend in a second direction DR2 crossing the first direction DR1. A number of the sub-pixels SP may represent a pixel. For example, a first one of the sub-pixels SP could be a red sub-pixel of the pixel, a second one of the sub-pixels SP could be a green sub-pixel of the pixel and third one of the sub-pixels SP could be a blue sub-pixel of the pixel, but embodiments are not limited to these colors.

The driving controller 200 may receive input image data IMG and an input control signal CONT from a main processor (for example, a graphic processing unit GPU or the like). For example, the input image data IMG may include red image data, green image data, and blue image data. In an embodiment, the input image data IMG may further include white image data. As another example, the input image data IMG may include magenta image data, yellow image data, and cyan image data. The input control signal CONT may include a master clock signal and a data enable signal. The input control signal CONT may further include a vertical synchronization signal and a horizontal synchronization signal.

The driving controller 200 may generate a first control signal CONT1, a second control signal CONT2, a third control signal CONT3, and a data signal DATA based on the input image data IMG and the input control signal CONT.

The driving controller 200 may generate the first control signal CONT1 for controlling an operation of the gate driver 300 based on the input control signal CONT and output the first control signal CONT1 to the gate driver 300. The first control signal CONT1 may include a vertical start signal and a gate clock signal.

The driving controller 200 may generate the second control signal CONT2 for controlling an operation of the data driver 400 based on the input control signal CONT and output the second control signal CONT2 to the data driver 400. The second control signal CONT2 may include a horizontal start signal and a load signal.

The driving controller 200 may receive the input image data IMG and the input control signal CONT and generate the data signal DATA. The driving controller 200 may output the data signal DATA to the data driver 400.

The driving controller 200 may receive the input image data IMG and the input control signal CONT to generate the third control signal CONT3. The driving controller 200 may output the third control signal CONT3 to the gamma voltage generator 500.

The gate driver 300 may generate gate signals for driving the gate lines GL in response to the first control signal CONT1 received from the driving controller 200. The gate driver 300 may output the gate signals to the gate lines GL. For example, the gate driver 300 may sequentially output the gate signals to the gate lines GL.

The data driver 400 may receive the second control signal CONT2 and the data signal DATA from the driving controller 200. The data driver 400 may generate data voltages obtained by converting the data signal DATA into an analog voltage. The data driver 400 may output the data voltages to the data line DL.

The data driver 400 may receive a gamma voltage VG from the gamma voltage generator 500. The gamma voltage VG may include a gamma voltage V0 of 0 grayscale (that is, the lowest grayscale) to a gamma voltage V255 of 255 grayscale (that is, the highest grayscale). The data driver 400 may generate the data voltage by selecting the gamma voltage VG corresponding to the grayscale of the data signal DATA.

The gamma voltage generator 500 may receive the third control signal CONT3 from the driving controller 200. The gamma voltage generator 500 may receive a first gamma lookup table GLUT1 and a second gamma lookup table GLUT2 from the memory device 600. In an embodiment, the gamma voltage generator 500 generates the gamma voltage VG based on at least one of the first gamma lookup table GLUT1 and the second gamma lookup table GLUT2. In an embodiment, the gamma voltage generator 500 selects a driving frequency to be used to drive the display panel 100 from among a plurality of driving frequencies, selects one of the first gamma lookup table GLUT1 and the second gamma lookup table GLUT2 that corresponds to or is closest to the selected driving frequency, and then uses the selected gamma lookup table to calculate any needed gamma voltages to be used by the data driver 400. In an embodiment, the first gamma lookup table GLUT1 is pre-loaded to the memory 600 and the display device (e.g., a driving controller 200) calculates the second gamma lookup table GLUT2 using the first gamma lookup table GLUT1.

The first gamma lookup table GLUT1 and the second gamma lookup table GLUT2 may include the gamma voltage VG according to a driving frequency and the grayscale of the display panel 100. In an embodiment, the first gamma lookup table GLUT1 and the second gamma lookup table GLUT2 include the gamma voltage VG according to the driving frequency, the grayscale, and a dimming level of the display panel 100. However, the disclosure is not limited to these conditions or to this number of conditions for determining the gamma voltage VG.

Here, the dimming level may be a value that adjusts a luminance of the display device. For example, as the dimming level increases, the luminance for the same grayscale may increase. For example, when the dimming level is 1000 nit, a maximum luminance displayed by the display device may be 1000 nit. However, the dimming level may not display the maximum luminance. In an embodiment, the dimming level may be set by a user. However, the disclosure is not limited thereto. For example, the dimming level may be changed automatically without an operation of the user.

In an embodiment, the first gamma lookup table GLUT1 includes the gamma voltage VG determined by measurement during a process. In this embodiment, the second gamma lookup table GLUT2 is generated by an artificial intelligence model based on the first gamma lookup table GLUT1.

The artificial intelligence model may include a plurality of layers of an artificial neural network. The artificial neural network may be one of deep neural network (DNN), convolutional neural network (CNN), recurrent neural network (RNN), restricted boltzmann machine (RBM), deep belief network (DBN), bidirectional recurrent deep neural network (BRDNN), deep Q-network, or a combination of two or more of the above, but is not limited to the examples described above.

The memory device 600 may include a first gamma lookup table GLUT1 and a second gamma lookup table GLU2. For example, the memory device 600 may include a non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, and a ferroelectric random access memory (FRAM) device, and/or a volatile memory device such as a dynamic random access memory (DRAM) device, a static random access memory (SRAM) device, and a mobile DRAM device.

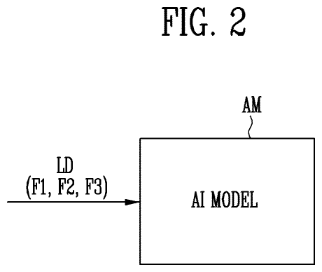

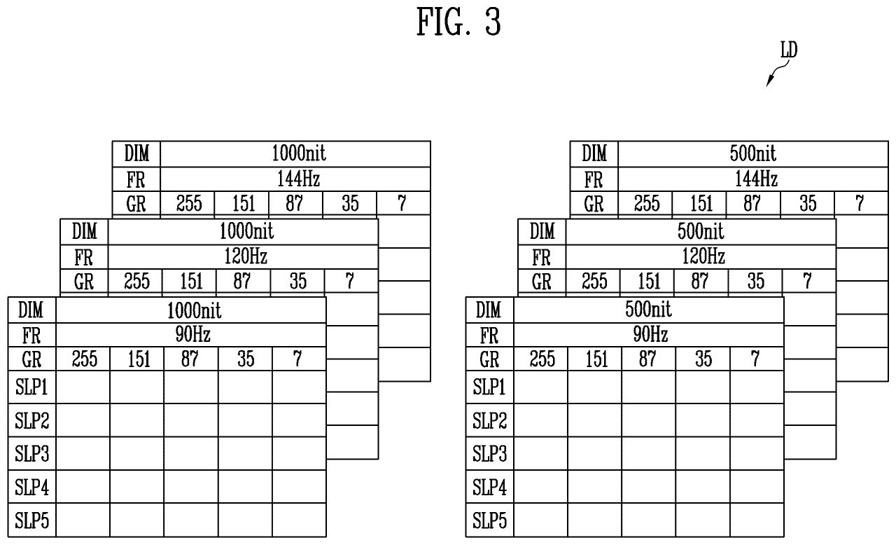

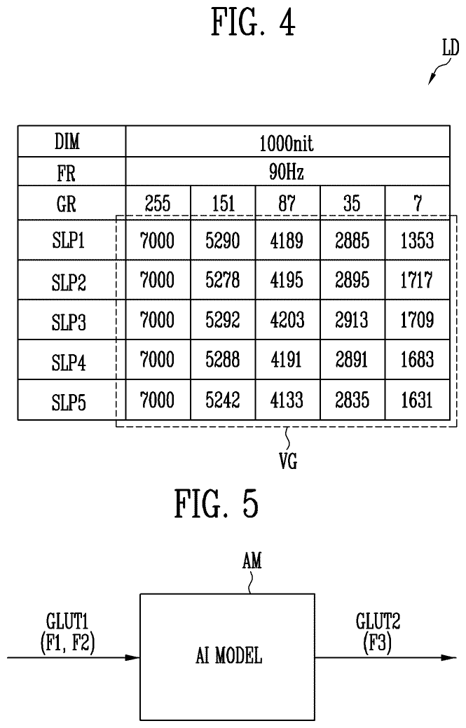

FIG. 2 is a diagram illustrating an example of training the artificial intelligence model for generating the second gamma lookup table of the display device of FIG. 1, FIG. 3 is a diagram illustrating an example of training data of FIG. 2, and FIG. 4 is a table illustrating an example of a portion of the training data of FIG. 3 corresponding to a dimming level of 1000 nit and a driving frequency of 90 Hz.

The table of FIG. 4 illustrates the gamma voltage VG of sample display devices SLP1 to SLP5 as a digital value, and even though the digital value is the same, an analog voltage value of the gamma voltage VG may be different. However, in FIG. 3, the gamma voltage VG is omitted.

Referring to FIGS. 2 to 4, an artificial intelligence model AM may be trained using the gamma voltage VG of the sample display devices SLP1 to SLP5 according to a first driving frequency F1, the gamma voltage VG of the sample display devices SLP1 to SLP5 according to a second driving frequency F2, and the gamma voltage VG of the sample display devices SLP1 to SLP5 according to a third driving frequency F3 as training data LD. In an embodiment, the artificial intelligence model AM is trained using the gamma voltage VG of the sample display devices SLP1 to SLP5 according to the first driving frequency F1 and the dimming level DIM, the gamma voltage VG of the sample display devices SLP1 to SLP5 according to the second driving frequency F2 and the dimming level DIM, and the gamma voltage VG of the sample display devices SLP1 to SLP5 according to the third driving frequency F3 and the dimming level DIM as the training data LD.

Training of the artificial intelligence model AM may be performed by the display device (e.g., the driving controller 200, an electronic device including the display device, or a separate computing device.

In the present embodiment, it is exemplified that the gamma voltage VG of the sample display devices SLP1 to SLP5 according to the first to third driving frequencies F1, F2, and F3 is used, but the disclosure is not limited to this number of driving frequency FR used for training. In addition, in the present embodiment, it is exemplified that five sample display devices SLP1 to SLP5 are used for training, but the disclosure is not limited to this number of sample display devices SLP1 to SLP5 used for training.

The sample display devices SLP1 to SLP5 are display devices for extracting the training data LD. The display device of FIG. 1 may one of the sample display devices SLP1 to SLP5 or be a separate display device.

For example, as shown in FIG. 3, the training data LD may include the gamma voltage VG of the sample display devices SLP1 to SLP5 according to the driving frequency FR, the dimming level DIM, and a representative grayscale. For example, as shown in FIG. 4, the training data LD may include the gamma voltage VG according to a driving frequency FR of 90 Hz, a dimming level DIM of 1000 nits, and representative grayscales of 255 grayscale, 151 grayscale, 87 grayscale, 35 grayscale, and 7 grayscale.

However, the disclosure is not limited to conditions of a certain type or a certain number of conditions for determining the gamma voltage VG, and is not limited to a certain number of driving frequencies FR, dimming levels DIM, and representative grayscales.

The artificial intelligence model AM may receive the gamma voltage VG according to the driving frequency FR and the dimming level DIM through the training data LD and may be trained to infer the gamma voltage VG according to another driving frequency FR and dimming level DIM. For example, when the first gamma voltage table GLUT1 of FIG. 1 includes the gamma voltage VG according to the first driving frequency F1 and the second driving frequency F2, and the second gamma voltage table GLUT2 of FIG. 1 includes the gamma voltage VG according to the third driving frequency F3, the artificial intelligence model AM may be trained to infer the gamma voltage VG according to the third driving frequency F3 from the gamma voltage VG according to the first driving frequency F1 and the second driving frequency F2. For example, the trained artificial intelligence model (AM) may receive the gamma voltage VG according to the first driving frequency F1 and the gamma voltage VG according to the second driving frequency F2, and output the gamma voltage VG according to the third driving frequency F3. That is, since the second gamma lookup table GLUT2 is generated by the artificial intelligence model AM, a ratio of the gamma voltage VG of the second gamma lookup table GLUT2 and the gamma voltage VG of the first gamma lookup table GLUT1 may not be the same for each grayscale GR, dimming level DIM, or driving frequency FR.

In the present embodiment, it is exemplified that the gamma voltage VG according to one driving frequency (for example, the third driving frequency F3) is inferred from the gamma voltage VG according to two driving frequencies (for example, the first and second driving frequencies F1 and F2), but the disclosure is not limited to this number of driving frequencies FR used for inference and this number of inferred driving frequencies FR.

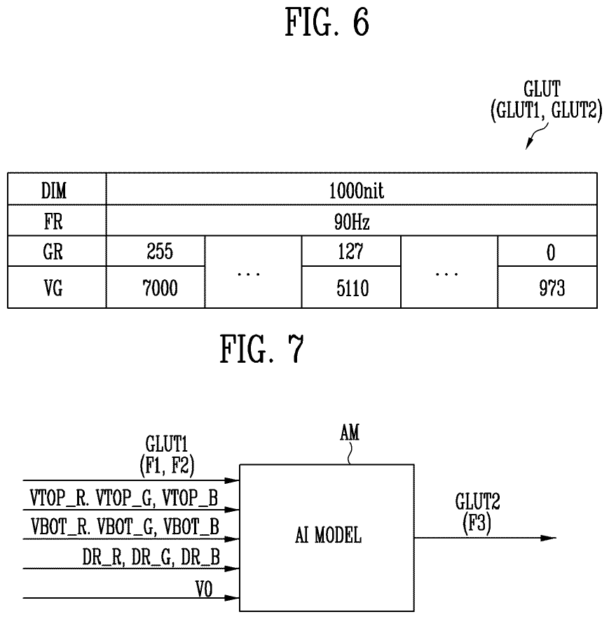

FIG. 5 is a diagram illustrating an example in which the artificial intelligence model of FIG. 2 generates the second gamma lookup table, and FIG. 6 is a diagram illustrating an example of a portion of the gamma lookup table of the display device of FIG. 1 corresponding to a dimming level of 1000 nit and a driving frequency of 90 Hz.

The table of FIG. 6 illustrates the gamma voltage VG of the display device as a digital value.

Referring to FIGS. 5 and 6, the artificial intelligence model AM generates the second gamma lookup table GLUT2 based on the first gamma lookup table GLUT1. The first gamma lookup table GLUT1 may include the gamma voltage VG according to the first driving frequency F1 and the second driving frequency F2, and the second gamma lookup table GLUT2 may include the gamma voltage VG according to the third driving frequency F3.

However, the disclosure is not limited to the number of driving frequencies FR included in the first gamma lookup table GLUT1 and the second gamma lookup table GLUT2.

In an embodiment, the first gamma lookup table GLUT1 includes the gamma voltage VG according to the first and second driving frequencies F1 and F2 and the dimming level DIM, and the second gamma lookup table GLUT2 includes the gamma voltage VG according to the third driving frequency F3 and the dimming level DIM. For example, as shown in FIG. 6, a portion of the gamma lookup table GLUT may include the gamma voltage VG according to each grayscale GR corresponding to a dimming level DIM of 1000 nit and a driving frequency FR of 90 Hz. For example, when the dimming level DIM is selected as one of three values and the driving frequency FR is selected as one of three values, the number of gamma voltages VG for each grayscale may be nine.

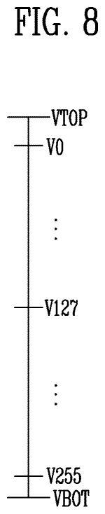

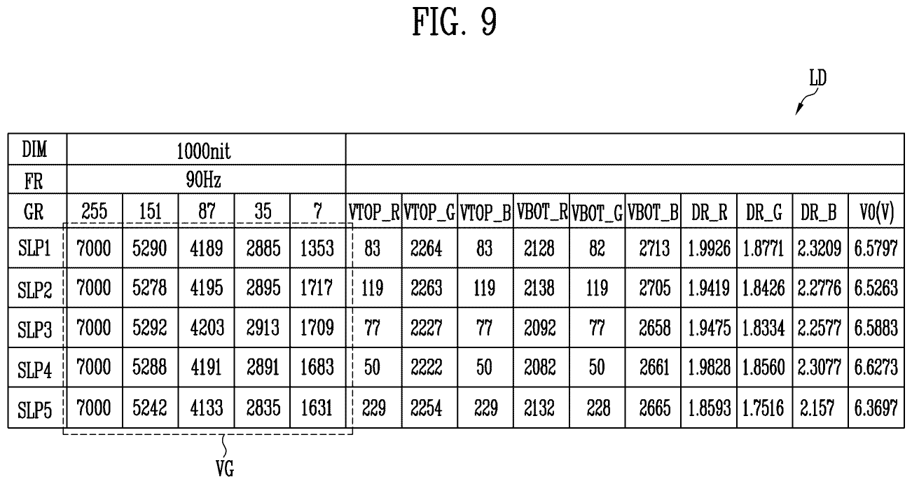

FIG. 7 is a diagram illustrating an example in which an artificial intelligence model of a display device generates a second gamma lookup table according to an embodiment of the disclosure, FIG. 8 is a diagram illustrating a top voltage and a bottom voltage, and FIG. 9 is a table illustrating a portion of training data of the display device of FIG. 7 corresponding to a dimming level of 1000 nit and a driving frequency of 90 Hz.

The table of FIG. 9 may illustrate the gamma voltage VG of the sample display devices SLP1 to SLP5 as a digital value, and even though the digital value is the same, an analog voltage value of the gamma voltage VG may be different.

Since the display device according to the present embodiments is substantially the same as a configuration of the display device of FIG. 1 except that the artificial intelligence model AM receives top voltages VTOP_R, VTOP_G, and VTOP_B, bottom voltages VBOT_R, VBOT_G, and VBOT_B, data swing ranges DR_R, DR_G, and DR_B, and a lowest grayscale of gamma voltage V0, the same reference numbers and symbols are used for equal or similar components, and an overlapping description is omitted.

Referring to FIGS. 1 and 7, the artificial intelligence model AM may receive at least one of the first gamma lookup table GLUT1, the top voltages VTOP_R, VTOP_G, and VTOP_B, the bottom voltages VBOT_R, VBOT_G, and VBOT_B, the data swing ranges DR_R, DR_G, and DR_B, and the lowest grayscale of gamma voltage V0 to generate the second gamma lookup table GLUT2. As the number of different types of data received by the artificial intelligence model AM increases, inference accuracy of the gamma voltage VG may be increased.

The data swing ranges DR_R, DR_G, and DR_B may correspond to a difference of the gamma voltage VG between grayscales. For example, a difference between the lowest grayscale of gamma voltage V0 and the highest grayscale of gamma voltage V255 may increase as the data swing range DR_R, DR_G, and DR_B increases. For example, the data swing ranges DR_R, DR_G, and DR_B may be a ratio of the gamma voltage VG of a first grayscale (for example, 255 grayscale) and the gamma voltage VG of a second grayscale (for example, 0 grayscale). However, the disclosure is not limited to this method of determining the data swing ranges DR_R, DR_G, and DR_B.

The gamma voltage VG may vary according to a displayed color. Accordingly, the data swing ranges DR_R, DR_G, and DR_B may include the data swing range DR_R for a first color, a data swing range DR_G for a second color, and the data swing range DR_B for a third color. In addition, the top voltages VTOP_R, VTOP_G, and VTOP_B may include the top voltage VTOP_R for the first color, the top voltage VTOP_G for the second color, and the top voltage VTOP_B for the third color. In addition, the bottom voltages VBOT_R, VBOT_G, and VBOT_B may include the bottom voltage VBOT_R for the first color, the bottom voltage VBOT_G for the second color, and the bottom voltage VBOT_B for the third color. For example, the first color may be red, the second color may be green, and the third color may be blue.

Referring to FIGS. 1 and 8, the display device may generate the gamma voltages VG through a top voltage VTOP and a bottom voltage VBOT. For example, the gamma voltage VG may be determined as a voltage between the top voltage VTOP and the bottom voltage VBOT. For example, the lowest grayscale of gamma voltage V0 may be less than or equal to the top voltage VTOP, and the highest grayscale of gamma voltage V255 may be greater than or equal to the bottom voltage VBOT.

The top voltage VTOP and the bottom voltage VBOT may be input as an external voltage or generated by converting the external voltage. However, the disclosure is not limited to this method of generating the top voltage VTOP and the bottom voltage VBOP. In an embodiment, the top voltage VTOP is a highest supply voltage supported by the display device and the bottom voltage VBOT is a lowest supply voltage supported by the display device or a ground voltage.

In the present embodiment, it is exemplified that the gamma voltage VG decreases as the grayscale increases, but the disclosure is not limited thereto. For example, the gamma voltage VG may decrease as the grayscale decreases.

Referring to FIG. 9, the artificial intelligence model AM may be trained using the gamma voltage VG of the sample display devices SLP1 to SLP5 according to the first driving frequency F1 and at least one of the top voltages VTOP_R, VTOP_G, and VTOP_B, the bottom voltages VBOT_R, VBOT_G, and VBOT_B, the data swing ranges DR_R, DR_G, and DR_B, and the lowest grayscale of gamma voltage V0, the gamma voltage VG of the sample display devices SLP1 to SLP5 according to the second driving frequency F2 and at least one of the top voltages VTOP_R, VTOP_G, and VTOP_B, the bottom voltages VBOT_R, VBOT_G, and VBOT_B, the data swing ranges DR_R, DR_G, and DR_B, and the lowest grayscale of gamma voltage V0, and the gamma voltage VG of the sample display devices SLP1 to SLP5 according to the third driving frequency F3 and at least one of the top voltages VTOP_R, VTOP_G, and VTOP_B, the bottom voltages VBOT_R, VBOT_G, and VBOT_B, the data swing ranges DR_R, DR_G, and DR_B, and the lowest grayscale of gamma voltage V0 as the training data LD. In an embodiment, the artificial intelligence model AM may be trained using the gamma voltage VG of the sample display devices SLP1 to SLP5 according to the first driving frequency F1, the dimming level DIM, and at least one of the top voltages VTOP_R, VTOP_G, and VTOP_B, the bottom voltages VBOT_R, VBOT_G, and VBOT_B, the data swing ranges DR_R, DR_G, and DR_B, and the lowest grayscale of gamma voltage V0, the gamma voltage VG of the sample display devices SLP1 to SLP5 according to the second driving frequency F2, the dimming level DIM, and at least one of the top voltages VTOP_R, VTOP_G, and VTOP_B, the bottom voltages VBOT_R, VBOT_G, and VBOT_B, the data swing ranges DR_R, DR_G, and DR_B, and the lowest grayscale of gamma voltage V0, and the gamma voltage VG of the sample display devices SLP1 to SLP5 according to the third driving frequency F3, the dimming level DIM, and at least one of the top voltages VTOP_R, VTOP_G, and VTOP_B, the bottom voltages VBOT_R, VBOT_G, and VBOT_B, the data swing ranges DR_R, DR_G, and DR_B, and the lowest grayscale of gamma voltage V0 as the training data LD.

In the present embodiment, it is exemplified that the gamma voltage VG of the sample display devices SLP1 to SLP5 according to the first to third driving frequencies F1, F2, and F3 is used, but the disclosure is not limited to this number of driving frequencies FR used for training. In addition, in the present embodiment, it is exemplified that five sample display devices SLP1 to SLP5 are used for training, but the disclosure is not limited to this number of sample display devices SLP1 to SLP5 used for training.

For example, as shown in FIG. 9, the training data LD may include the driving frequency FR, the dimming level DIM, the representative gray scale, and the gamma voltage VG of the sample display devices SLP1 to SLP5 according to the top voltages VTOP_R, VTOP_G, and VTOP_B, the bottom voltages VBOT_R, VBOT_G, and VBOT_B, the data swing ranges DR_R, DR_G, and DR_B, and the lowest grayscale of gamma voltage V0. For example, the learning data LD may include a driving frequency FR of 90 Hz, a dimming level DIM of 1000 nits, and a gamma voltage VG of representative grayscales of 255 grayscale, 151 grayscale, 87 grayscale, 35 grayscale, and 7 grayscale. For example, the training data LD may include the top voltage VTOP_R, VTOP_G, and VTOP_B, the bottom voltage VBOT_R, VBOT_G, and VBOT_B, the data swing range DR_R, DR_G, and DR_B, and the lowest grayscale of gamma voltage V0 of each of the sample display device SLP1 to SLP5.

However, the disclosure is not limited to conditions of a certain type or a certain number of conditions for determining the gamma voltage VG, and is not limited to a certain number of driving frequencies FR, dimming levels DIM, and representative grayscales.

The artificial intelligence model AM may be trained to infer the gamma voltage VG according to the driving frequency FR and the dimming level DIM by receiving the driving frequency FR, the dimming level DIM, and at least one of the top voltages VTOP_R, VTOP_G, and VTOP_B, the bottom voltages VBOT_R, VBOT_G, and VBOT_B, the data swing ranges DR_R, DR_G, and DR_B and the lowest grayscale of gamma voltage V0. Since the top voltages VTOP_R, VTOP_G, and VTOP_B, the bottom voltages VBOT_R, VBOT_G, and VBOT_B, the data swing ranges DR_R, DR_G, and DR_B, and the lowest grayscale of gamma voltage V0 of the display device are constant even though the driving frequency FR changes, the artificial intelligence model AM may not output top voltages VTOP_R, VTOP_G, and VTOP_B, bottom voltages VBOT_R, VBOT_G, and VBOT_B, data swing ranges DR_R, DR_G, and DR_B, and the lowest grayscale of gamma voltage V0 except for the second gamma lookup table GLUT2 of FIG. 1.

In the present embodiment, it is exemplified that the gamma voltage VG according to one driving frequency (for example, the third driving frequency F3) is inferred from the gamma voltage VG according to two driving frequencies (for example, the first and second driving frequencies F1 and F2), but the disclosure is not limited to this number of driving frequencies FR used for inference and this number of inferred driving frequencies FR.

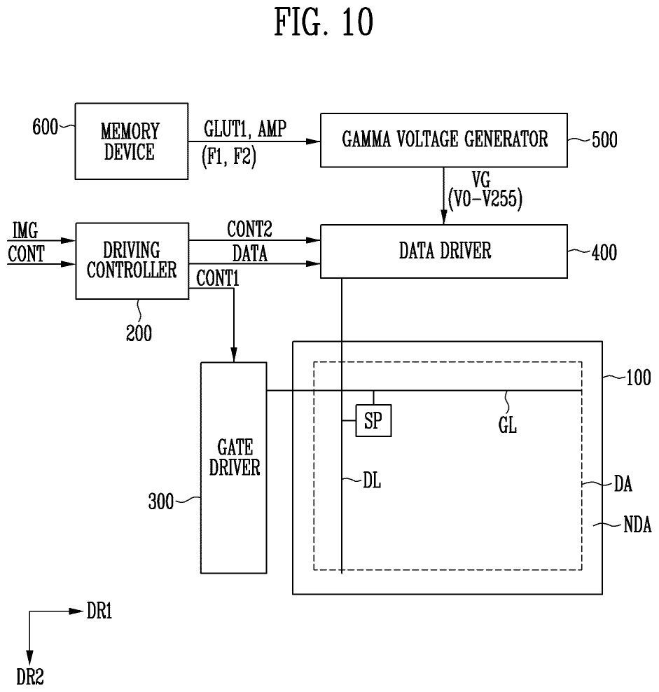

FIG. 10 is a block diagram illustrating a display device according to an embodiment of the disclosure.

Since the display device according to the present embodiment is substantially the same as the configuration of the display device of FIG. 1 except for storing a parameter AMP of the artificial intelligence model instead of storing the second gamma lookup table GLUT2 of FIG. 1, the same reference numbers and symbols are used for equal or similar components, and an overlapping description is omitted.

Referring to FIG. 10, the memory device 600 may store the first gamma lookup table GLUT1 and the parameter AMP of the artificial intelligence model. For example, the display device may implement the artificial intelligence model from the parameter AMP of the artificial intelligence model and generate the second gamma lookup table through the artificial intelligence model.

For example, when the artificial intelligence model is a neural network model, the parameters AMP of the artificial intelligence model may include weights, a bias, and a structure (e.g., the number of layers, the number of neurons in each layer, etc.). The display device may implement the artificial intelligence model from the weights, the biases, and the structure.

In an embodiment, the gamma voltage generator 500 may implement the artificial intelligence model by receiving the parameter AMP of the artificial intelligence model. In an embodiment, the driving controller 200 receives the parameter AMP of the artificial intelligence model, trains the artificial intelligence model, and provides the second gamma lookup table to the gamma voltage generator 500.

Accordingly, the display device may generate a gamma lookup table for various driving frequencies and generate gamma lookup tables for a plurality of driving frequencies regardless of a capacity of the memory device 600.

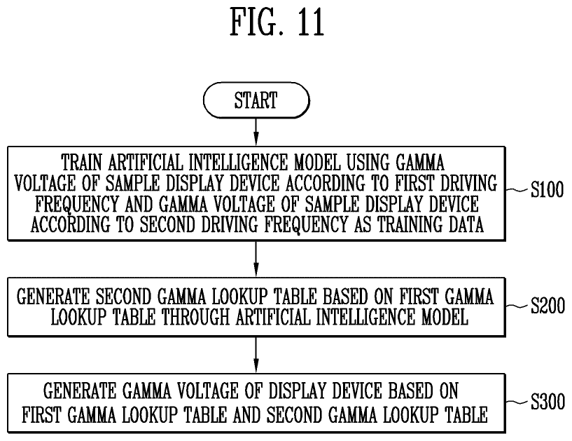

FIG. 11 is a flowchart illustrating a method of driving a display device according to embodiments of the disclosure.

Referring to FIG. 11, the method of driving the display device may train an artificial intelligence model using a gamma voltage of a sample display device according to a first driving frequency and a gamma voltage of a sample display device according to a second driving frequency as training data (S100), generate a second gamma lookup table based on a first gamma lookup table through the artificial intelligence model (S200), and generate the gamma voltage of the display device based on the first gamma lookup table and the second gamma lookup table (S300).

Specifically, the method of driving the display device may train the artificial intelligence model using trained data of the gamma voltage of the sample display device according to the first driving frequency and the gamma voltage of the sample display device according to the second driving frequency.

In an embodiment, the artificial intelligence model is trained using training data including the first driving frequency, the gamma voltage of the sample display device according to at least one of the top voltage, the bottom voltage, the data swing range, and the gamma voltage of the display device of the lowest grayscale, the second driving frequency, and the gamma voltage of the sample display device according to at least one of the top voltage, the bottom voltage, the data swing range, and the gamma voltage of the display device of the lowest grayscale.

Specifically, the method of driving the display device may generate the second gamma lookup table based on the first gamma lookup table through the artificial intelligence model (S200). In an embodiment, the first gamma lookup table includes the gamma voltage of the display device according to the first driving frequency, and the second gamma lookup table included the gamma voltage of the display device according to the second driving frequency. In an embodiment, the first gamma lookup table included the gamma voltage of the display device according to the first driving frequency and the second driving frequency, and the second gamma lookup table included the gamma voltage of the display device according to the third driving frequency. However, the disclosure is not limited to a certain number of driving frequencies used for inference or a certain number of inferred driving frequencies.

In an embodiment, the first gamma lookup table includes the gamma voltage of the display device according to the first driving frequency and the dimming level, and the second gamma lookup table includes the gamma voltage of the display device according to the second driving frequency and the dimming level.

In an embodiment, the artificial intelligence model generates the second gamma lookup table by receiving the first gamma lookup table and at least one of the top voltage, the bottom voltage, the data swing range, and the gamma voltage of the display device of the lowest grayscale.

In an embodiment, the second gamma lookup table may be stored in a memory. In an embodiment, the parameter of the artificial intelligence model may be stored in the memory device, and the display device may implement the artificial intelligence model from the parameter of the artificial intelligence model and generate the second gamma lookup table through the implemented artificial intelligence model.

The disclosure may be applied to a display device and an electronic device including the display device. For example, the disclosure may be applied to a digital television (TV), a three-dimensional (3D) TV, a mobile phone, a smart phone, a tablet computer, a virtual reality (VR) device, a personal computer (PC), a home electronic device, a notebook computer, a personal digital assistant (PDA), a portable media player (PMP), a digital camera, a music player, a portable game console, a navigation system, and the like.

Although described with reference to the above embodiments, it will be understood that those skilled in the art can variously modify and change the disclosure without departing from the spirit and scope of the disclosure described in the claims below.

What is claimed is:

1. A display device comprising:
a display panel including a sub-pixel;
a data driver configured to generate a data voltage based on a gamma voltage and provide the data voltage to the sub-pixel; and
a gamma voltage generator configured to receive a first gamma lookup table and a second gamma lookup table and generate the gamma voltage based on at least one of the first gamma lookup table and the second gamma lookup table, and provide the gamma voltage to the data driver,
wherein an artificial intelligence model is trained to generate the second gamma lookup table comprising gamma voltages for a target driving frequency using the first gamma lookup table including gamma voltages for a sample display device driven at different respective sample driving frequencies.

2. The display device according to claim 1, further comprising:
a memory device configured to store the first gamma lookup table and the second gamma lookup table.

3. The display device according to claim 1, further comprising:
a memory device configured to store the first gamma lookup table and a parameter of the artificial intelligence model.

4. The display device according to claim 1, wherein the sample driving frequencies differ from the target driving frequency.

5. The display device according to claim 1, wherein the artificial intelligence model is trained additionally using at least one of a top voltage, a bottom voltage less than the top voltage, a data swing range, and a gamma voltage of a lowest grayscale among grayscales supported by the display panel.

6. The display device according to claim 5, wherein the gamma voltage is determined as a voltage between the top voltage and the bottom voltage.

7. The display device according to claim 5, wherein a difference between the gamma voltage of the lowest grayscale and the gamma voltage of a highest grayscale among the grayscales increases as the data swing range increases.

8. The display device according to claim 1, wherein the first gamma lookup table includes the gamma voltages according to the sample driving frequencies and a dimming level, and the second gamma lookup table includes the gamma voltages according to the target driving frequency and the dimming level.

9. A method of driving a display device, the method comprising:
receiving a first gamma lookup table including gamma voltages for a sample display device driven at different respective sample driving frequencies;
training an artificial intelligence model to generate a second gamma lookup table comprising gamma voltages for a target driving frequency using the first gamma lookup table;
generating a gamma voltage of the display device based on at least one of the first gamma lookup table and the second gamma lookup table; and
providing the gamma voltage to a data driver of the display device.

10. The method according to claim 9, further comprising storing the second gamma lookup table in a memory device of the display device.

11. The method according to claim 9, further comprising storing a parameter of the artificial intelligence model in a memory device of the display device.

12. The method according to claim 9, wherein the training additionally uses at least one of a top voltage, a bottom voltage less than the top voltage, a data swing range, and a gamma voltage of the display device of a lowest grayscale among grayscales supported by the display device.

13. The method according to claim 12, wherein the first gamma lookup table includes the gamma voltages according to the sample driving frequencies and a dimming level, and
the second gamma lookup table includes the gamma voltages according to the target driving frequency and the dimming level.

14. The method according to claim 9, further comprising:
the data driver generating a data voltage based on the gamma voltage; and
the data driving providing the data voltage to a sub-pixel of a display panel of the display device.

15. A display device comprising:
a display panel including a sub-pixel;
a data driver configured to generate a data voltage based on a gamma voltage and provide the data voltage to the sub-pixel; and
a driving controller configured to train an artificial intelligence model to generate the gamma voltage for a target driving frequency using training data including first gamma voltages for a first sample driving frequency and a first dimming level and second gamma voltages for a second sample driving frequency different from the first sample driving frequence and a second dimming level.

16. The display device of claim 15, wherein the first dimming level and the second dimming level are the same.

17. The display device of claim 15, wherein the first dimming level and the second dimming level are different from one another.

18. The display device of claim 15, wherein the driving controller trains the artificial intelligence model additionally using a top voltage and a bottom voltage less than the top voltage, and the gamma voltage is determined as a voltage between the top voltage and the bottom voltage.

19. The display device of claim 15, wherein the driving controller trains the artificial intelligence model additionally using a data swing range and a gamma voltage of a lowest grayscale among grayscales supported by the display panel.

20. The display device of claim 19, wherein a difference between the gamma voltage of the lowest grayscale and the gamma voltage of a highest grayscale among the grayscales increases as the data swing range increases.
